(19) United States
(12) Patent Application Publication
(10) Pub. No.: US 2017/0242471 A1
(43) Pub. Date: Aug. 24, 2017

(54) METHOD FOR CONTROLLING STANDBY STATE AND ELECTRONIC DEVICE

(71) Applicants: Le Holdings (Beijing) Co., Ltd., Beijing (CN); LeCloud Computing Co., Ltd., Beijing (CN)

(72) Inventor: Yong MA, Beijing (CN)

(21) Appl. No.: 15/243,939

(22) Filed: Aug. 22, 2016

Related U.S. Application Data
(63) Continuation of application No. PCT/CN2016/088590, filed on Jul. 5, 2016.

(30) Foreign Application Priority Data
Feb. 24, 2016 (CN) 201610099922.1

(51) Int. Cl. G06F 1/32; H04N 7/18; G06F 3/01

(52) U.S. Cl. CPC G06F 1/3206; G06F 3/013; H04N 7/185

(57) ABSTRACT

A method for controlling standby state is disclosed. The method includes: at an electronic device with an acceleration sensor and a front-mounted camera, continuously collecting acceleration data generated by the acceleration sensor in a standby state; determining whether a pre-boot action takes place according to the acceleration data; activating the front-mounted camera if the pre-boot action takes place; determining whether a user is gazing at the screen according to an image captured by the front-mounted camera; and exiting the standby state to enter into a normal operation state if the user is gazing at the screen.

### CROSS-REFERENCE TO RELATED APPLICATION

The application is a continuation application of PCT International patent application No. PCT/CN2016/088590, filed on Jul. 5, 2016, which claims priority to Chinese Patent Application No. 201610099922.1, filed with the Chinese Patent Office on Feb. 24, 2016, both of which are herein incorporated by reference in their entireties.

### TECHNICAL FIELD

The present disclosure relates to the technical field of terminal controlling, and particularly, to a method for controlling standby state and an electronic device.

### BACKGROUND

With continuous advancement of the science and technologies as well as the economy, various kinds of mobile terminals in the electronics technical field such as smartphones, tablet computers or the like have become very popular, and are still under continuous innovation and development.

As a kind of mobile device for which the battery endurance is a great concern, mobile terminals usually are controlled to enter into a standby state (or termed as a hibernation state) when they are not being used by users and are awakened again when they are needed to operate so as to save the electric power of the mobile terminals.

A typical standby mode management method adopts the following scheme: a standby button or a virtual standby button is pressed to enter into the standby state, or the mobile terminal enters into the standby state when no operation takes place within a preset timeout period; and when it is necessary to awaken the mobile terminal, an awakening button or a virtual awakening button is pressed to awaken the mobile terminal.

### SUMMARY

A method for controlling standby state is provided in an embodiment of the present disclosure. The method includes: at an electronic device with an acceleration sensor and a front-mounted camera, continuously collecting acceleration data generated by the acceleration sensor in a standby state; determining whether a pre-boot action takes place according to the acceleration data; activating the front-mounted camera if the pre-boot action takes place; determining whether a user is gazing at the screen according to an image captured by the front-mounted camera; and exiting the standby state to enter into a normal operation state if the user is gazing at the screen.

An electronic device is provided in another embodiment of the present disclosure. The electronic device includes at least one processor and a memory. The memory is communicably connected with the at least one processor for storing instructions executable by the at least one processor. Wherein execution of the instructions by the at least one processor causes the at least one processor to:
continuously collect acceleration data generated by the acceleration sensor in a standby state;
determine whether a pre-boot action takes place according to the acceleration data;
activate the front-mounted camera if the pre-boot action takes place;
determine whether a user is gazing at the screen according to an image captured by the front-mounted camera; and
exit the standby state to enter into a normal operation state if the user is gazing at the screen.

A non-transitory computer-readable storage medium is provided in still another embodiment of the present disclosure. The non-transitory computer-readable storage medium stores executable instructions, wherein when executed by an electronic device, causes the electronic device to:
continuously collect acceleration data generated by the acceleration sensor in a standby state;
determine whether a pre-boot action takes place according to the acceleration data;
activate the front-mounted camera if the pre-boot action takes place;
determine whether a user is gazing at the screen according to an image captured by the front-mounted camera; and
exit the standby state to enter into a normal operation state if the user is gazing at the screen.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart diagram of an embodiment of a method for controlling standby state provided in the present disclosure;

FIG. 2 is a schematic flowchart diagram of another embodiment of the method for controlling standby state provided in the present disclosure;

FIG. 3 is a schematic modular diagram of an embodiment of a mobile terminal for controlling standby state provided in the present disclosure;

FIG. 4 is a schematic diagram illustrating displaying of a screen of a mobile terminal after prompt information is sent in the embodiments of the method and the apparatus provided in the present disclosure; and

FIG. 5 is a schematic structural diagram of an embodiment of a mobile terminal for controlling standby state provided in the present disclosure.

### DETAILED DESCRIPTION

To make the objectives, technical solutions and advantages of the present disclosure clearer, a detailed description will be further made on embodiments of the present disclosure with reference to the attach drawings.

It shall be appreciated that, all expressions using terms “the first” and “the second” as used in the embodiments of the present disclosure are intended to distinguish two entities or parameters which have the same name but actually are different from each other. Therefore, the terms such as “the first” and “the second” are only for convenience of description and should not be construed to limit to the embodiments of the present disclosure, and this will not be further described in the following embodiments.

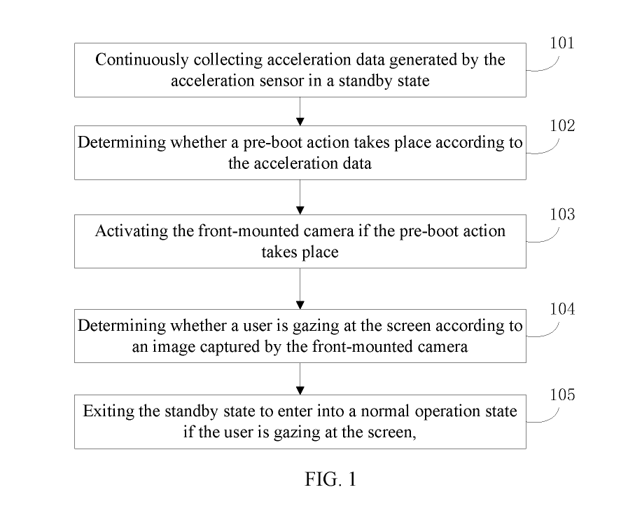

In a first aspect of the present disclosure, a method for controlling standby state that can achieve standby state controlling without the need of the user's manual operation is provided. FIG. 1 is a schematic flowchart diagram of an embodiment of the method for controlling standby state provided in the present disclosure.

The method for controlling standby state is applied to a mobile terminal which includes an acceleration sensor and a front-mounted camera. The acceleration sensor is a sensor or a device similar to the sensor that can detect movement of the mobile terminal and convert physical data (e.g., velocity, acceleration, displacement and etc) generated by the movement into acceleration data or transmit the physical data to a processor of the mobile terminal to obtain acceleration data through calculation, e.g., a gyroscope, a gravity sensor, a vibration sensor, an accelerator and so on.

The method includes the following steps:

Step 101: continuously collecting acceleration data generated by the acceleration sensor in a standby state; i.e., activating monitoring of the acceleration sensor when the mobile terminal is in the standby state.

Step 102: determining whether a pre-boot action takes place according to the acceleration data.

The pre-boot action means that the mobile terminal experiences a preset action because of a user's operation, and this action usually indicates that the user needs to use the mobile terminal (e.g., the mobile terminal being picked up by the user). Determining the pre-boot action may be accomplished by presetting in the mobile terminal that when there is a certain kind of change in the acceleration data or there is a certain kind of changing tendency in the acceleration data, it is considered that a pre-booting action takes place.

Step 103: activating the front-mounted camera to capture an image if the pre-boot action takes place.

Step 104: determining whether a user is gazing at the screen according to an image captured by the front-mounted camera.

Determining whether the user is gazing at the screen may be accomplished by recognizing a human face image in the image through a human face recognizing technology, and determining that the user is gazing at the screen if a complete human face image is recognized; or by recognizing whether there is an image of one or both eyes of the user in the human face image and determining that the user is gazing at the screen if there is the image of one or both eyes. Of course, the step of determining whether the user is gazing at the screen may also be designed depending on practical needs instead of adopting these two schemes.

Step 105: exiting the standby state to enter into a normal operation state if the user is gazing at the screen.

As can be seen from the above embodiment, the method for controlling standby state provided in the present disclosure determines whether a pre-boot action takes place in the standby state, activates the front-mounted camera to capture an image if the pre-boot action takes place, determines whether the user is gazing at the screen of the mobile terminal according to the image contents so that, when the user is gazing at the screen, determines that the mobile terminal is to be used, and then automatically switches the mobile terminal into the normal operation state. In this way, the user can start to use the mobile terminal without having to manually boot the mobile terminal, and this facilitates the user's operation and improves the user's experiences.

Further, in some exemplary embodiments, before the step 101 of continuously collecting acceleration data generated by the acceleration sensor in a standby state, the method may also include the following steps:
determining a current state, e.g., determining whether the current state is a normal operation state or a standby state;
activating the front-mounted camera if the current state is the normal operation state;
determining whether the user is gazing at the screen according to an image captured by the front-mounted camera;
if the user is not gazing at the screen, then continuously monitoring the state in which the user is not gazing at the screen and beginning to start timing;
determining whether a timing duration has reached a preset standby time limit;
if the timing duration has reached the preset standby time limit, then exiting the normal operation state to enter into the standby state; and
if a state in which the user is gazing at the screen is monitored before the timing duration reaches the preset standby time limit, then continuing to keep the normal operation state.

The preset standby time limit may be a time length default in the system, or a user-defined time length. The way to determine whether the user is gazing at the screen may be the same as those of the previous embodiment, so it will not be described again herein.

Thus, by determining whether the user is gazing at the screen, whether the user is using the mobile terminal can be known so that when the mobile terminal is not being used by the user (e.g., when the mobile terminal is put on a table) and when the mobile terminal has not been used for a preset standby time limit, the mobile terminal automatically enters into a standby state without the need of manual control of the user. This simplifies the user's operation on one hand, and saves electric power of the mobile terminal on the other hand.

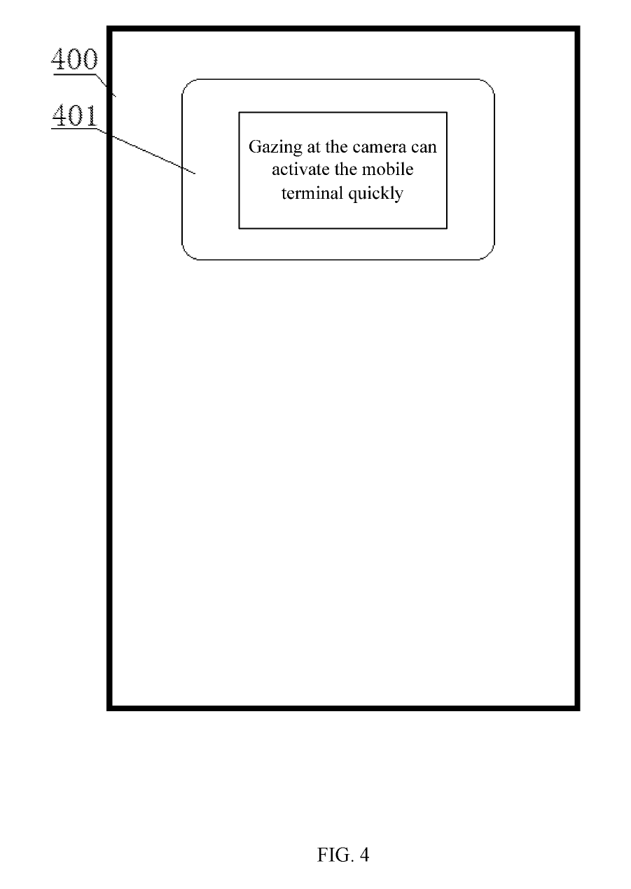

In some exemplary embodiments, after the step 103 of activating the front-mounted camera, the method further includes the following step: sending prompt information that prompts the user to gaze at the front-mounted camera. FIG. 4 shows a schematic view illustrating displaying of the screen 400 of the mobile terminal after the prompt information 401 is sent.

By setting the prompt information 401, the user can be prompted that gazing at the camera will activate the mobile terminal when it is necessary to utilize the front-mounted camera to determine whether the user is gazing at the screen. This helps to guide the user's operation and improves the user's experiences.

In some exemplary embodiments, the step 104 of determining whether a user is gazing at the screen according to an image captured by the front-mounted camera may specifically include the following steps:
determining whether there is an eye image in the image captured by the front-mounted camera. Here, human face recognition has to be made in the image captured by the front-mounted camera to extract a human face image therefrom, and then the eye image is extracted from the human face image. However, the human face recognition step may be skipped if the eye image can be directly extracted from the image captured by the front-mounted camera.
determining that the user is gazing at the screen if there is the eye image in the image captured by the front-mounted camera; and
determining that the user is not gazing at the screen if there is no eye image in the image captured by the front-mounted camera.

Determining whether the user is gazing at the screen by determining whether there is an eye image in the image captured by the front-mounted camera allows for inferring the current usage state of the mobile terminal more accurately.

In some exemplary embodiments, before the step 104 of determining whether the user is gazing at the screen according to an image captured by the front-mounted camera, the method further includes the following steps:
utilizing the front-mounted camera to capture an image within a preset capturing time.

The step 104 of determining whether the user is gazing at the screen according to an image captured by the front-mounted camera includes:
determining whether an eye image appears continuously in the image captured in a preset last time period of the preset capturing time. Here, human face recognition has to be made in the image captured by the front-mounted camera to extract a human face image therefrom, and then the eye image is extracted from the human face image. However, the human face recognition step may be skipped if the eye image can be directly extracted from the image captured by the front-mounted camera.
if the eye image appears continuously, then determining that the user is gazing at the screen; and
if the eye image appears uncontinuously, then determining that the user is not gazing at the screen.

The preset capturing time is a default value or is user-defined, the preset last time period is a last time period within the preset capturing time. Values of the preset last time period and the preset capturing time may be arbitrarily set depending on practical needs, for example, the preset capturing time being 0.5 s or 1 s, and the preset last time period being 0.3 s or 0.5 s. The main consideration of this arrangement is that, the front-mounted camera is automatically activated once the mobile terminal is picked up by the user, and at this point, the user has not begun to gaze at the screen yet. Therefore, the image captured at the preset last time period can more clearly reveal whether the user is gazing at the screen.

Determining whether the user is gazing at the screen by determining whether there is an eye image in the image captured by the front-mounted camera in the preset last time period within the preset capturing time allows for inferring the current usage state of the mobile terminal more accurately.

Additionally, in the above embodiments, apart from directly determining whether there is an eye image in the image captured by the camera, a distance from the eyes to the screen, the focus of line of sight or the like may be determined from the eye image to determine the usage state of the mobile terminal more accurately.

Further, in some exemplary embodiments, the step 102 of determining whether a pre-boot action takes place according to the acceleration data includes:
determining whether a change in acceleration takes place according to the acceleration data;
if the change in acceleration takes place, then determining whether a vertical component of the acceleration generated at a time instant when the change in acceleration takes place is larger than a preset vertical component threshold. The preset vertical component threshold may be a default value or a user-defined acceleration value which may be set depending on practical needs;
if the vertical component of the acceleration generated at the time instant when the change in acceleration takes place is larger than the preset vertical component threshold, then determining that a pre-boot action takes place;
by determining the vertical component of the acceleration, it can be inferred that the user is picking up the mobile terminal so as to predict that the user needs to activate the mobile terminal, and then the camera is activated for more accurate determination.

Sometimes, it is possible that the user is exercising carrying the mobile terminal (e.g., walking, running and etc), in which case the user does not need to use the mobile terminal and, therefore, the corresponding data shall be deleted.

Therefore, in some exemplary embodiments, the step 102 of determining whether a pre-boot action takes place according to the acceleration data may specifically includes the following steps:
determining whether a change in acceleration takes place according to the acceleration data;
if the change in acceleration takes place, then determining whether an average of vertical components of the acceleration collected in a preset acceleration calculation time period after the change in acceleration takes place is larger than the preset vertical component threshold and whether the vertical component at the last moment is directed upwards. The preset acceleration calculation time period may be a default value or a user-defined time period (e.g., 5 s); and the preset vertical component threshold may be a default value or a user-defined acceleration value which may be set depending on practical needs; and
if the average is larger than the preset vertical component threshold and the vertical component at the last moment is directed upwards, then determining that the pre-boot action takes place.

By determining whether an average of vertical components of the acceleration collected in a preset acceleration calculation time period after the change in acceleration takes place is larger than the preset vertical component threshold and whether the vertical component at the last moment is directed upwards, it can be inferred more accurately that the user is picking up the mobile terminal rather than is walking so as to predict that the user needs to use the mobile terminal, and then the camera is activated for more accurate determination.

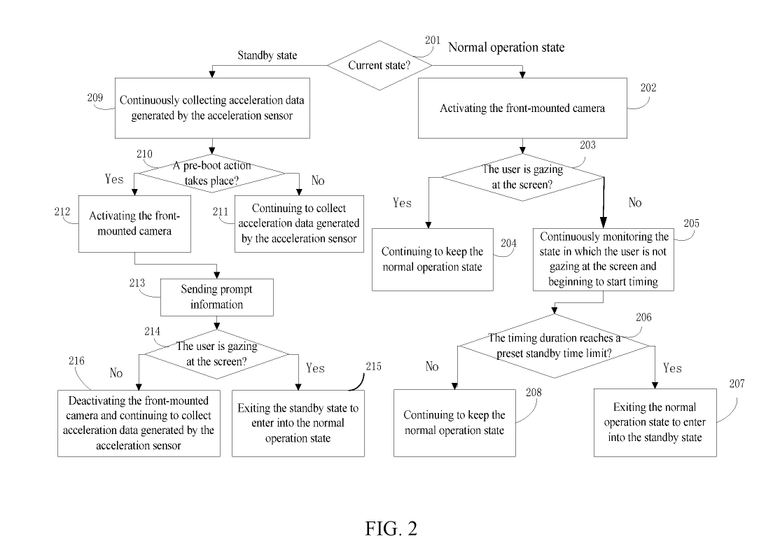

Following, another embodiment of the method for controlling standby state will be introduced. FIG. 2 is a schematic flowchart diagram of another embodiment of the method for controlling standby state provided in the present disclosure.

The method for controlling standby state includes the following steps:

Step 201: determining a current state of the mobile terminal, e.g., determining whether the terminal is in a normal operation state or a standby state;

Step 202: activating the front-mounted camera if the mobile terminal is in the normal operation state;

Step 203: determining whether the user is gazing at the screen according to an image captured by the front-mounted camera;

Step 204: if the user is gazing at the screen, continuing to keep the normal operation state;

Step 205: if the user is not gazing at the screen, continuously monitoring the state in which the user is not gazing at the screen and beginning to start timing;

Step 206: determining whether the timing duration reaches a preset standby time limit;

Step 207: if the timing duration reaches the preset standby time limit, exiting the normal operation state to enter into the standby state;

Step 208: if it is monitored that the user is gazing at the screen before the timing duration reaches the preset standby time limit, then continuing to keep the normal operation state;

Step 209: if the mobile terminal is in the standby state, continuously collecting acceleration data generated by the acceleration sensor;

Step 210: determining whether a pre-boot action takes place according to the acceleration data;

Step 211: if no pre-boot action takes place, then continuing to collect acceleration data generated by the acceleration sensor;

Step 212: if the pre-boot action takes place, then activating the front-mounted camera;

Step 213: sending prompt information that prompts the user to gaze at the front-mounted camera;

Step 214: determining whether the user is gazing at the screen according to the image captured by the front-mounted camera;

Step 215: if the user is gazing at the screen, then exiting the standby state to enter into the normal operation state; and

Step 216: if the user is not gazing at the screen, then deactivating the front-mounted camera and continuing to collect acceleration data generated by the acceleration sensor.

As can be seen from the above embodiments, the method for controlling standby state provided in the present disclosure determines whether the user moves the face away from the screen in the normal operation state so that the mobile terminal automatically enters into the standby state when not being used by the user. This facilitates the user's operation, saves the electric power of the mobile terminal, and improves the user's experiences. Meanwhile, the method for controlling standby state determines whether a pre-boot action takes place in the standby state, activates the front-mounted camera to capture an image if the pre-boot action takes place, determines whether the user is gazing at the screen of the mobile terminal according to the image contents so that, when the user is gazing at the screen, it is determined that the mobile terminal is to be used, and then automatically switches the mobile terminal into the normal operation state. In this way, the user can start to use the mobile terminal without having to manually boot the mobile terminal, and this facilitates the user's operation and improves the user's experiences.

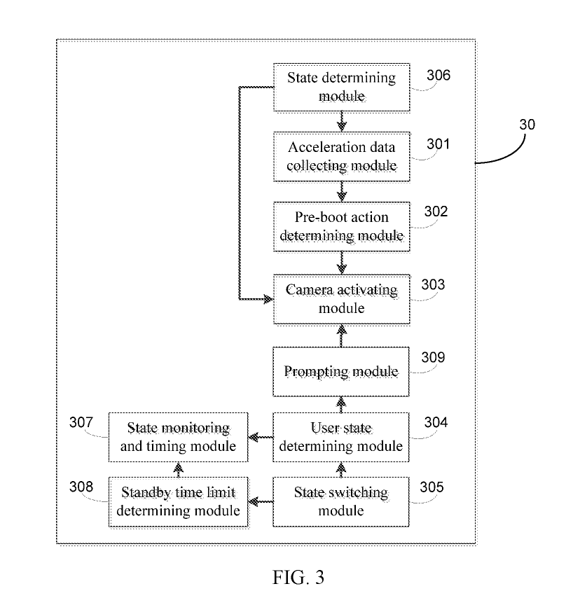

In a second aspect, the present disclosure provides a mobile terminal for controlling standby state which can achieve standby state controlling without the need of the user's manual operation. FIG. 3 is a schematic modular diagram of an embodiment of a mobile terminal 30 for controlling standby state provided in the present disclosure.

The mobile terminal 30 for controlling standby state includes: an acceleration data collecting module 301, a pre-boot action determining module 302, a camera activating module 303, a user state determining module 304, and a state switching module 305.

The acceleration data collecting module 301 is configured to continuously collect acceleration data generated by the acceleration sensor in a standby state, that is, activate monitoring of the acceleration sensor when the mobile terminal 30 is in the standby state.

The pre-boot action determining module 302 is configured to determine whether a pre-boot action takes place according to the acceleration data.

The pre-boot action means that the mobile terminal 30 experiences a preset action because of a user's operation, and this action usually indicates that the user needs to use the mobile terminal 30 (e.g., the mobile terminal 30 being picked up by the user). Determining the pre-boot action may be accomplished by presetting in the mobile terminal 30 that when there is a certain kind of change in the acceleration data or there is a certain kind of changing tendency in the acceleration data, it is considered that a pre-booting action takes place.

The camera activating module 303 is configured to activate the front-mounted camera if the pre-boot action takes place.

The user state determining module 304 is configured to determine whether a user is gazing at the screen according to an image captured by the front-mounted camera.

Determining whether the user is gazing at the screen may be accomplished by recognizing a human face image in the image through a human face recognizing technology, and determining that the user is gazing at the screen if a complete human face image is recognized; or by recognizing whether there is an image of one or both eyes of the user in the human face image and determining that the user is gazing at the screen if there is the image of one or both eyes. Of course, the step of Determining whether the user is gazing at the screen may also be designed depending on practical needs instead of adopting these two schemes.

The state switching module 305 is configured to exit the standby state to enter into a normal operation state if the user is gazing at the screen.

As can be seen from the above embodiments, the mobile terminal 30 for controlling standby state provided in the present disclosure determines whether a pre-boot action takes place in the standby state, activates the front-mounted camera to capture an image if the pre-boot action takes place, determine whether the user is gazing at the screen of the mobile terminal according to the image contents so that, when the user is gazing at the screen, determines that the mobile terminal 30 is to be used, and then automatically switch the mobile terminal 30 into the normal operation state. In this way, the user can start to use the mobile terminal 30 without having to manually boot the mobile terminal, and this facilitates the user's operation and improves the user's experiences.

Further, in some exemplary embodiments, the mobile terminal 30 also includes: a state determining module 306, a state monitoring and timing module 307, and a standby time limit determining module 308.

The state determining module 306 is configured to determine a current state, e.g., determine whether the mobile terminal 30 is in a normal operation state or a standby state.

The camera activating module 303 is further configured to activate the front-mounted camera if the current state is the normal operation state.

The user state determining module 304 is configured to determine whether the user is gazing at the screen according to an image captured by the front-mounted camera.

The state monitoring and timing module 307 is configured to, if the user is not gazing at the screen, continuously monitor the state in which the user is not gazing at the screen and beginning to start timing.

The standby time limit determining module 308 is configured to determine whether a timing duration has reached a preset standby time limit.

If the timing duration has reached the preset standby time limit, then the state switching module 305 is further configured to exit the normal operation state to enter into the standby state.

The preset standby time limit may be a time length default in the system, or a user-defined time length. The way to determine whether the user is gazing at the screen may be the same as those of the previous embodiments, so it will not be described again herein.

Thus, by determining whether the user is gazing at the screen, whether the user is using the mobile terminal 30 can be known so that when the mobile terminal 30 is not being used by the user (e.g., when the mobile terminal 30 is put on a table) and when the mobile terminal 30 has not been used for a preset standby time limit, the mobile terminal 30 automatically enters into a standby state without the need of manual control of the user. This simplifies the user's operation on one hand, and saves electric power of the mobile terminal 30 on the other hand.

In some exemplary embodiments, the mobile terminal 30 further includes a prompting module 309 configured to send prompt information that prompts the user to gaze at the front-mounted camera. FIG. 4 is a schematic diagram illustrating displaying of a screen 400 of the mobile terminal 30 after prompt information 401 is sent.

By setting the prompt information 401, the user can be prompted that gazing at the screen will activate the mobile terminal 30 when it is necessary to utilize the front-mounted camera to determine whether the user is gazing at the screen. This helps to guide the user's operation and improves the user's experiences.

In some exemplary embodiments, the user state determining module 304 is specifically configured to:
determine whether there is an eye image in the image captured by the front-mounted camera. Here, human face recognition has to be made in the image captured by the front-mounted camera to extract a human face image therefrom, and then the eye image is extracted from the human face image. However, the human face recognition step may be skipped if the eye image can be directly extracted from the image captured by the front-mounted camera.
determine that the user is gazing at the screen if there is the eye image in the image captured by the front-mounted camera; and
determine that the user is not gazing at the screen if there is no eye image in the image captured by the front-mounted camera.

Determining whether the user is gazing at the screen by determining whether there is an eye image in the image captured by the front-mounted camera allows for inferring the current usage state of the mobile terminal 30 more accurately.

In some exemplary embodiments, the user state determining module 304 is specifically configured to:
utilize the front-mounted camera to capture an image within a preset capturing time;
determine whether an eye image appears continuously in the image captured in a preset last time period of the preset capturing time. Here, human face recognition has to be made in the image captured by the front-mounted camera to extract a human face image therefrom, and then the eye image is extracted from the human face image. However, the human face recognition step may be skipped if the eye image can be directly extracted from the image captured by the front-mounted camera.
if the eye image appears continuously, then determine that the user is gazing at the screen; and
if no eye image appears continuously, then determine that the user is not gazing at the screen.

The preset capturing time is a default value or is user-defined, and the preset last time period is a last time period within the preset capturing time. Values of the preset last time period and the preset capturing time may be arbitrarily set depending on practical needs, for example, the preset capturing time being 0.5 s or 1 s, and the preset last time period being 0.3 s or 0.5 s. The main consideration of this arrangement is that, the front-mounted camera is automatically activated once the mobile terminal is picked up by the user, and at this point, the user has not begun to gaze at the screen yet. Therefore, the image captured at the preset last time period can more clearly reveal whether the user is gazing at the screen.

Determining whether the user is gazing at the screen by determining whether there is an eye image in the image captured by the front-mounted camera in the preset last time period within the preset capturing time allows for inferring the current usage state of the mobile terminal more accurately.

Additionally, in the above embodiments, apart from directly determining whether there is an eye image in the image captured by the camera, a distance from the eyes to the screen, the focus of line of sight or the like may be determined from the eye image to determine the usage state of the mobile terminal more accurately.

Further, in some exemplary embodiments, the pre-boot action determining module 302 is specifically configured to:
determine whether a change in acceleration takes place according to the acceleration data;
if the change in acceleration takes place, then determine whether a vertical component of the acceleration generated at a time instant when the change in acceleration takes place is larger than a preset vertical component threshold. The preset vertical component threshold may be a default value or a user-defined acceleration value which may be set depending on practical needs; and
if the vertical component of the acceleration generated at the time instant when the change in acceleration takes place is larger than the preset vertical component threshold, then determine that a pre-boot action takes place.

By determining the vertical component of the acceleration, it can be inferred that the user is picking up the mobile terminal 30 so as to predict that the user needs to activate the mobile terminal 30, and then the camera is activated for more accurate determination.

Sometimes, it is possible that the user carrying the mobile terminal 30 is exercising (e.g., walking, running and etc), in which case the user need not use the mobile terminal 30 and, therefore, the corresponding data shall be deleted.

Therefore, in some exemplary embodiments, the pre-boot action determining module 302 is specifically configured to:
determine whether a change in acceleration takes place according to the acceleration data;
if the change in acceleration takes place, then determine whether an average of vertical components of the acceleration collected in a preset acceleration calculation time period after the change in acceleration takes place is larger than the preset vertical component threshold and whether the vertical component at the last moment is directed upwards. The preset acceleration calculation time period may be a default value or a user-defined time period (e.g., 5 s); and the preset vertical component threshold may be a default value or a user-defined acceleration value which may be set depending on practical needs; and
if the average is larger than the preset vertical component threshold and the vertical component at the last moment is directed upwards, then determine that the pre-boot action takes place.

By determining whether an average of vertical components of the acceleration collected in a preset acceleration calculation time period after the change in acceleration takes place is larger than the preset vertical component threshold and whether the vertical component at the last moment is directed upwards, it can be inferred more accurately that the user is picking up the mobile terminal 30 rather than is walking so as to predict that the user needs to use the mobile terminal 30, and then the camera is activated for more accurate determination.

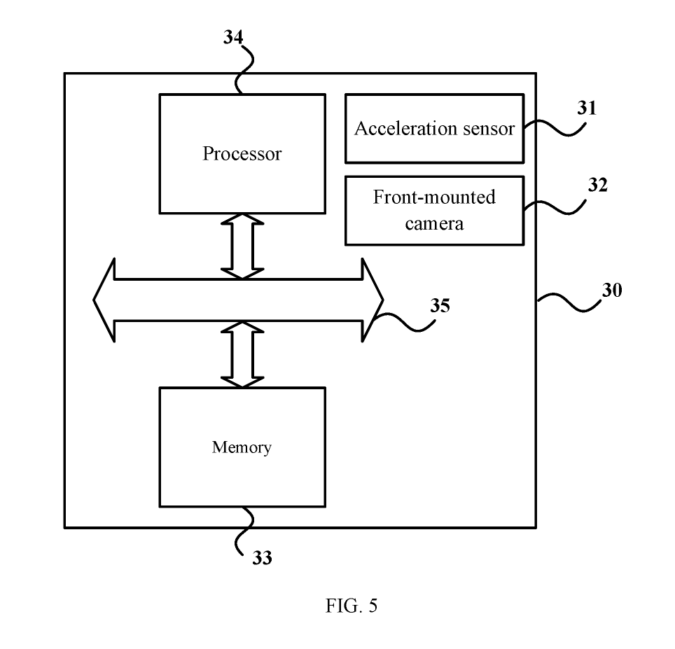

FIG. 5 is a schematic structural diagram of a mobile terminal 30 for controlling standby state provided in an embodiment of the present disclosure. As shown in FIG. 5, the mobile terminal 30 for controlling standby state includes an acceleration sensor 31, a front-mounted camera 32, a memory 33, a processor 34 and a bus system 35. The processor 34 and the memory 33 are connected with each other via the bus system 35. The memory 33 is configured to store instructions. The processor 34 is configured to execute instructions stored in the memory 33 and is configured to: continuously collect acceleration data generated by the acceleration sensor in a standby state; determine whether a pre-boot action takes place according to the acceleration data; activate the front-mounted camera if the pre-boot action takes place; determine whether a user is gazing at the screen according to an image captured by the front-mounted camera; and if the user is gazing at the screen, then exit the standby state to enter into a normal operation state.

The memory 33 of the mobile terminal 30 may be a non-transitory computer readable storage medium for storing computer executable instructions which, when being executed by one or more processors, for example the processor 34, enable the processor 34 to execute steps of the method in the embodiments described above, e.g., the steps 101 to 105 described in FIG. 1 or the steps 201 to 216 described in FIG. 2.

The computer executable instructions may also be stored and/or transmitted in any non-transitory computer readable storage medium for use in an instruction execution system, apparatus or device or for use in combination with an instruction execution system, apparatus or device. The instruction execution system, apparatus or device is, for example, a computer-based system, a system including a processor, or some other system that can obtain instructions from the instruction execution system, apparatus or device and execute the instructions. For purpose of this document, the “non-transitory computer readable storage medium” may be any tangible medium that contains or stores computer executable instructions which may be used by or in combination with the instruction execution system, apparatus or device. The non-transitory computer readable storage medium may include but not limited to magnetic, optical and/or semiconductor storage devices. Examples of these storage devices include magnetic disks, optical disks based on CD, DVD or Blu-ray technologies, and persistent solid-state storages (e.g., flash memories, solid-state drives and etc).

In some embodiments, the modules 301 to 309 may be computer software program modules stored in the memory 33. In operation, the modules 301 to 309 described in each of the above embodiments are obtained by the processor 34 from the memory 33 and executed to accomplish functions of the modules 301 to 309 described in the above embodiments.

It shall be understood that, in the embodiments of the present disclosure, the processor 34 may be a central processing unit (CPU). The processor 34 may also be some other general-purpose processor, digital signal processor (DSP), application specific integrated circuit (ASIC), field programmable gate array (FPGA) or some other programmable logic element, discrete gate or transistor logic element, discrete hardware component and etc. The general-purpose processor may be a microprocessor or may be any common processor.

In addition to data buses, the bus system 35 may also include power supply buses, control buses, state signal buses and so on. However, for clarity of description, all kinds of buses are labeled as the bus system in the attached drawings.

In the embodiments of the present disclosure, parts and arrangement of the mobile terminal 30 are not limited to what shown in FIG. 5, but may also include other or additional parts in various arrangements.

During the implementation, the steps of the method or modules of the apparatus described above may be implemented by integrated logic circuits in hardware form or instructions in software form in the processor 34. The steps of the methods or modules of the apparatus disclosed in the embodiments of this application may be directly embodied as hardware processors, or by a combination of hardware modules and software modules in the processor. The software modules may reside in a storage medium well-known in the art such as a random access memory (RAM), a flash memory, a read only memory (ROM), a programmable ROM, an electrically erasable programmable memory, or a register. The storage medium resides in the memory 33, and information stored in the memory 33 is read by the processor 34 to accomplish the steps of the method described above via hardware of the processor 34. This will not be detailed herein for purpose of simplicity.

The mobile terminal 30 provided in the embodiments of the present disclosure determines whether a pre-boot action takes place in the standby state, activates the front-mounted camera to capture an image if the pre-boot action takes place, determines whether the user is gazing at the screen of the mobile terminal 30 according to the image contents so that, when the user is gazing at the screen, determine that the mobile terminal 30 is to be used, and then automatically switch the mobile terminal 30 into the normal operation state. In this way, the user can start to use the mobile terminal 30 without having to manually boot the mobile terminal 30, and this facilitates the user's operation and improves the user's experiences.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Accordingly, any omissions, modifications, equivalent replacements, and alterations within the spirits and principles of the present disclosure shall be included in the scope of the present disclosure.

What is claimed is:

1. A method for controlling standby state, comprising:
at an electronic device with an acceleration sensor and a front-mounted camera;
continuously collecting acceleration data generated by the acceleration sensor in a standby state;
determining whether a pre-boot action takes place according to the acceleration data;
activating the front-mounted camera if the pre-boot action takes place;
determining whether a user is gazing at the screen according to an image captured by the front-mounted camera; and
exiting the standby state to enter into a normal operation state if the user is gazing at the screen.

2. The method according to claim 1, before the continuously collecting acceleration data generated by the acceleration sensor in a standby state, comprising:
determining a current state;
activating the front-mounted camera if the current state is the normal operation state;
determining whether the user is gazing at the screen according to an image captured by the front-mounted camera;
continuously monitoring the state in which the user is not gazing at the screen and beginning to start timing if the user is not gazing at the screen;
determining whether a timing duration has reached a preset standby time limit; and
exiting the normal operation state to enter into the standby state if the timing duration has reached the preset standby time limit.

3. The method according to claim 1, after activating the front-mounted camera, comprising:
sending a prompt message that prompts the user to gaze at the front-mounted camera.

4. The method according to claim 1, wherein the determining whether the user is gazing at the screen according to an image captured by the front-mounted camera comprises:
determining whether there is an eye image in the image captured by the front-mounted camera;
determining that the user is gazing at the screen if there is the eye image in the image captured by the front-mounted camera; and
determining that the user is not gazing at the screen if there is no eye image in the image captured by the front-mounted camera.

5. The method according to claim 1, before the determining whether the user is gazing at the screen according to an image captured by the front-mounted camera, comprising:
utilizing the front-mounted camera to capture an image within a preset capturing time;
wherein the determining whether the user is gazing at the screen according to an image captured by the front-mounted camera comprises:
determining whether an eye image appears continuously in the image captured in a preset last time period of the preset capturing time;
determining that the user is gazing at the screen if the eye image appears continuously; and
determining that the user is not gazing at the screen if the eye image appears uncontinuously.

6. The method according to claim 1, wherein the determining whether a pre-boot action takes place according to the acceleration data comprises:
determining whether an acceleration is changed according to the acceleration data;
determining whether a vertical component of the acceleration generated at a time instant when the acceleration is changed is larger than a preset vertical component threshold if the acceleration is changed; and
determining that the pre-boot action takes place if the vertical component of the acceleration generated at the time instant when the acceleration is changed is larger than the preset vertical component threshold.

7. The method according to claim 1, wherein the determining whether a pre-boot action takes place according to the acceleration data comprises:
determining whether an acceleration is changed according to the acceleration data;
determining whether an average of vertical components of the acceleration collected in a preset acceleration calculation time period after the acceleration is changed is larger than the preset vertical component threshold and whether the vertical component at the last moment is directed upwards if the acceleration is changed; and
determining that the pre-boot action takes place if the average is larger than the preset vertical component threshold and the vertical component at the last moment is directed upwards.

8. An electronic device, comprising:
at least one processor; and
a memory communicably connected with the at least one processor for storing instructions executable by the at least one processor, wherein execution of the instructions by the at least one processor causes the at least one processor to:
continuously collect acceleration data generated by the acceleration sensor in a standby state;
determine whether a pre-boot action takes place according to the acceleration data;
activate the front-mounted camera if the pre-boot action takes place;
determine whether a user is gazing at the screen according to an image captured by the front-mounted camera; and
exit the standby state to enter into a normal operation state if the user is gazing at the screen.

9. The electronic device according to claim 8, wherein before the continuously collecting acceleration data generated by the acceleration sensor in a standby state, execution of the instructions by the at least one processor causes the at least one processor to:
determine a current state;
activate the front-mounted camera if the current state is the normal operation state;
determine whether the user is gazing at the screen according to an image captured by the front-mounted camera;
continuously monitor the state in which the user is not gazing at the screen and beginning to start timing if the user is not gazing at the screen;
determine whether a timing duration has reached a preset standby time limit; and
exit the normal operation state to enter into the standby state if the timing duration has reached the preset standby time limit.

10. The electronic device according to claim 8, wherein after the activating the front-mounted camera, execution of the instructions by the at least one processor causes the at least one processor to:
send a prompt message that prompts the user to gaze at the front-mounted camera.

11. The electronic device according to claim 8, wherein the determining whether the user is gazing at the screen according to an image captured by the front-mounted camera comprises:
determining whether there is an eye image in the image captured by the front-mounted camera;
determining that the user is gazing at the screen if there is the eye image in the image captured by the front-mounted camera; and
determining that the user is not gazing at the screen if there is no eye image in the image captured by the front-mounted camera.

12. The electronic device according to claim 8, wherein before the determining whether the user is gazing at the screen according to an image captured by the front-mounted camera, execution of the instructions by the at least one processor causes the at least one processor to:
utilize the front-mounted camera to capture an image within a preset capturing time;
wherein the determining whether the user is gazing at the screen according to an image captured by the front-mounted camera comprises:
determining whether an eye image appears continuously in the image captured in a preset last time period of the preset capturing time;
determining that the user is gazing at the screen if the eye image appears continuously; and
determining that the user is not gazing at the screen if the eye image appears uncontinuously.

13. The electronic device according to claim 8, wherein the determining whether a pre-boot action takes place according to the acceleration data comprises:
determining whether an acceleration is changed according to the acceleration data;
determining whether a vertical component of the acceleration generated at a time instant when the acceleration is changed is larger than a preset vertical component threshold if the acceleration is changed; and
determining that the pre-boot action takes place if the vertical component of the acceleration generated at the time instant when the acceleration is changed is larger than the preset vertical component threshold.

14. The electronic device according to claim 8, wherein the determining whether a pre-boot action takes place according to the acceleration data comprises:
determining whether an acceleration is changed according to the acceleration data;
determining whether an average of vertical components of the acceleration collected in a preset acceleration calculation time period after the acceleration is changed is larger than the preset vertical component threshold and whether the vertical component at the last moment is directed upwards if the acceleration is changed; and
determining that the pre-boot action takes place if the average is larger than the preset vertical component threshold and the vertical component at the last moment is directed upwards.

15. A non-transitory computer-readable storage medium storing executable instructions, wherein when executed by an electronic device, causes the electronic device to:
continuously collect acceleration data generated by the acceleration sensor in a standby state;
determine whether a pre-boot action takes place according to the acceleration data;
activate the front-mounted camera if the pre-boot action takes place;
determine whether a user is gazing at the screen according to an image captured by the front-mounted camera; and
exit the standby state to enter into a normal operation state if the user is gazing at the screen.

16. The non-transitory computer-readable storage medium according to claim 15, wherein before the continuously collecting acceleration data generated by the acceleration sensor in a standby state, the executable instructions are executed by the electronic device, causes the electronic device to:
determine a current state;
activate the front-mounted camera if the current state is the normal operation state;
determine whether the user is gazing at the screen according to an image captured by the front-mounted camera;
continuously monitor the state in which the user is not gazing at the screen and beginning to start timing if the user is not gazing at the screen;
determine whether a timing duration has reached a preset standby time limit; and
exit the normal operation state to enter into the standby state if the timing duration has reached the preset standby time limit.

17. The non-transitory computer-readable storage medium according to claim 15, wherein the determining whether the user is gazing at the screen according to an image captured by the front-mounted camera comprises:
determining whether there is an eye image in the image captured by the front-mounted camera;
determining that the user is gazing at the screen if there is the eye image in the image captured by the front-mounted camera; and
determining that the user is not gazing at the screen if there is no eye image in the image captured by the front-mounted camera.

18. The non-transitory computer-readable storage medium according to claim 15, wherein before the determining whether the user is gazing at the screen according to an image captured by the front-mounted camera, the executable instructions are executed by the electronic device, causes the electronic device to:
utilize the front-mounted camera to capture an image within a preset capturing time;
wherein the determining whether the user is gazing at the screen according to an image captured by the front-mounted camera comprises:
determining whether an eye image appears continuously in the image captured in a preset last time period of the preset capturing time;
determining that the user is gazing at the screen if the eye image appears continuously; and
determining that the user is not gazing at the screen if the eye image appears uncontinuously.

19. The non-transitory computer-readable storage medium according to claim 15, wherein determining whether a pre-boot action takes place according to the acceleration data comprises:
determining whether an acceleration is changed according to the acceleration data;
determining whether a vertical component of the acceleration generated at a time instant when the acceleration is changed is larger than a preset vertical component threshold if the acceleration is changed; and
determining that the pre-boot action takes place if the vertical component of the acceleration generated at the time instant when the acceleration is changed is larger than the preset vertical component threshold.

20. The non-transitory computer-readable storage medium according to claim 15, wherein the determining whether a pre-boot action takes place according to the acceleration data comprises:
determining whether an acceleration is changed according to the acceleration data;
determining whether an average of vertical components of the acceleration collected in a preset acceleration calculation time period after the acceleration is changed is larger than the preset vertical component threshold and whether the vertical component at the last moment is directed upwards if the acceleration is changed; and
determining that the pre-boot action takes place if the average is larger than the preset vertical component threshold and the vertical component at the last moment is directed upwards.
